(19) United States
(12) Patent Application Publication
(10) Pub. No.: US 2009/0173451 A1
(43) Pub. Date: Jul. 9, 2009

(54) COLD WEATHER INSULATOR FILM REMOVAL AND EMERGENCY ESCAPE DEVICE

(75) Inventor: Frank J. Walker, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: Morgan Concepts, Inc., Union Lake, MI (US)

(21) Appl. No.: 12/347,455

(22) Filed: Dec. 31, 2008

Related U.S. Application Data
(60) Provisional application No. 61/018,549, filed on Jan. 2, 2008.

(51) Int. Cl. B32B 43/00

(52) U.S. Cl. 156/584

(57) ABSTRACT

A device for rapidly removing insulator film from a window in an emergency such as a fire includes tabs mounted to the insulator film a cord mounted to one or more of the tabs and a handle on the end of the cord to permit the film to be removed from the window by grasping the handle and pulling on the chord.

### CROSS-REFERENCE TO RELATED APPLICATIONS

This application claims priority of U.S. Provisional Patent Application Ser. No. 61/018,549, filed Jan. 2, 2008, which is incorporated herein by reference.

### FIELD OF THE INVENTION

The present invention relates to insulator film for windows and doors for homes and commercial buildings and the like and more particularly to such film provided with means for easy removal for egress in the event of an emergency

### BACKGROUND OF THE INVENTION

One method to reduce heating costs in cold climates is to install cold weather insulator film on the windows of a given structure. Such types of window insulation typically include a clear vinyl sheet covering the glass of the window and attached onto a window support structure using double sided adhesive tape. Once the clear vinyl sheet has been placed over the glass of the window and attached to the window support structure, air infiltration through the window unit can be significantly reduced and the air between the glass and the insulator film serves to reduce convection currents and acts as an insulating barrier to inhibit heat from exiting through the window.

Although such types of window insulation can significantly reduce the energy required to heat a given structure and thereby reduce energy bills, the removal of such a film is difficult and can take time. This is especially important if urgency is needed to exit the structure through the window. For example, if a fire is present within the structure, and a child and/or adult needs to exit through the window in order to escape the structure, removal of the cold weather insulator film can prove to be difficult and thereby result in injury or even death. As such, a device for ensuring the safe, convenient and quick removal of insulator film from a window unit would be desirable.

### SUMMARY OF THE INVENTION

The present invention is directed to a cold weather insulator film removal and/or emergency escape device. As such, the removal and/or emergency escape device for use on cold weather insulator film has utility as a safety device.

The cold weather insulator film removal device includes a corner tab and/or a center tab that is attached to a cold weather insulator film preferably using a double-sided adhesive mounting tape.

The adhesive mounting tape may also be used to attach the insulator film to the window structure. The corner tab and the center tab each have finger pull tabs that permit an individual to grasp and pull upon the corner and/or center tab. Pulling on the corner pull tab and/or central pull tab causes the removal of the insulator film from the window unit. In some instances, the finger pull tabs on the corner pull tab and/or central pull tab have an aperture for a cord to be placed through and attached to the corner pull tab and/or center pull tab. The cord, being attached to the corner pull tab and/or center pull tab, can extend therefrom and can have a handle attached to a distal end thereof. In the event that a rapid removal of the insulator film is required, an individual may grasp the handle on the cord and upon pulling, rapidly remove the insulator film that has been attached to the window support structure.

### BRIEF DESCRIPTION OF THE DRAWINGS

FIG. 1 is a diagrammatic view of the insulator film of the present invention attached to a window;

FIG. 2 is a view similar to FIG. 1 illustrating the insulator film of the present invention being removed from a window;

FIG. 3 is an enlarged fragmentary view of a portion of the insulator film shown in FIG. 1;

FIG. 4 is enlarged fragmentary view similar to FIG. 3 but illustrating the pull tabs of the invention located at a different corner of the insulator film; and

FIG. 5 is a diagrammatic view illustrating the manner of attaching the tabs to the film.

### DETAILED DESCRIPTION OF THE PREFERRED EMBODIMENTS

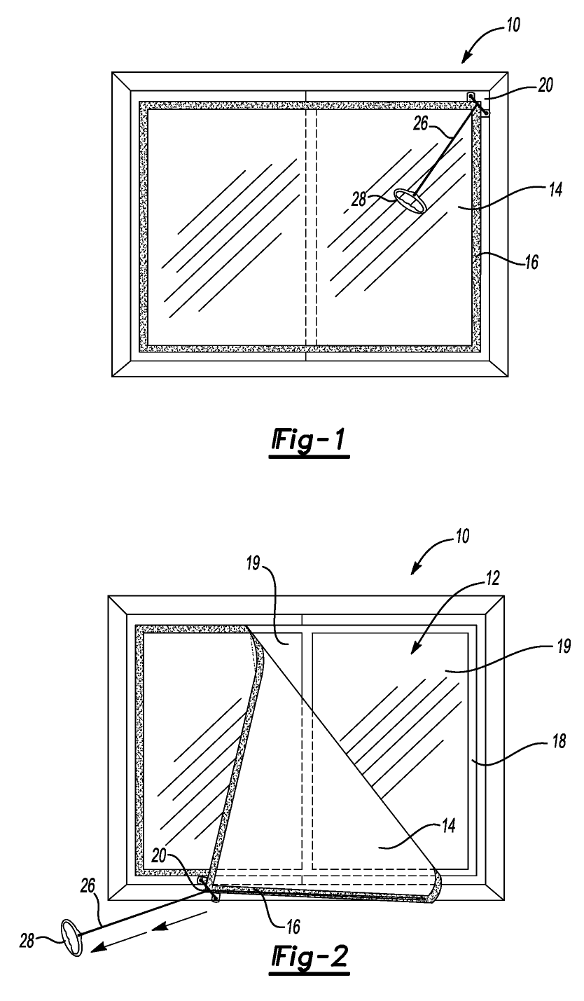

Turning now to FIG. 1, a window unit 10 is shown having a sliding window pane 12 that is covered with a cold weather insulator film 14 using double sided adhesive mounting tape 16. As shown in the drawing, the double sided adhesive mounting tape 16 is attached to a window frame or the molding 18 of the window unit 10. The double sided adhesive mounting tape 16 and the cold weather insulator film 14 attached thereto provide an insulating barrier over the glass pane and/or a plurality of glass panes 19 of the window 12.

The removal of the insulator film 14 that is securely adhered to the window frame 18 using the double sided adhesive mounting tape 16 can be tedious and possibly difficult. Thus in an effort to lessen this difficulty, a corner pull tab 20 and/or a central pull tab 22 are attached to the insulator film 14 as best seen in FIG. 2. As best seen in FIG. 5 the corner pull tab 20 and/or center pull tab 22 have a body 31 and 32 respectively which are positioned between the insulator film 14 and the window frame 18, i.e. “underneath” the insulator film 14 and preferably between the tape 16 and the frame 18 so that pulling on the tab 20 and/or tab 22 will urge the tape 16 and the film 14 to be removed from the frame 18 in a single piece.

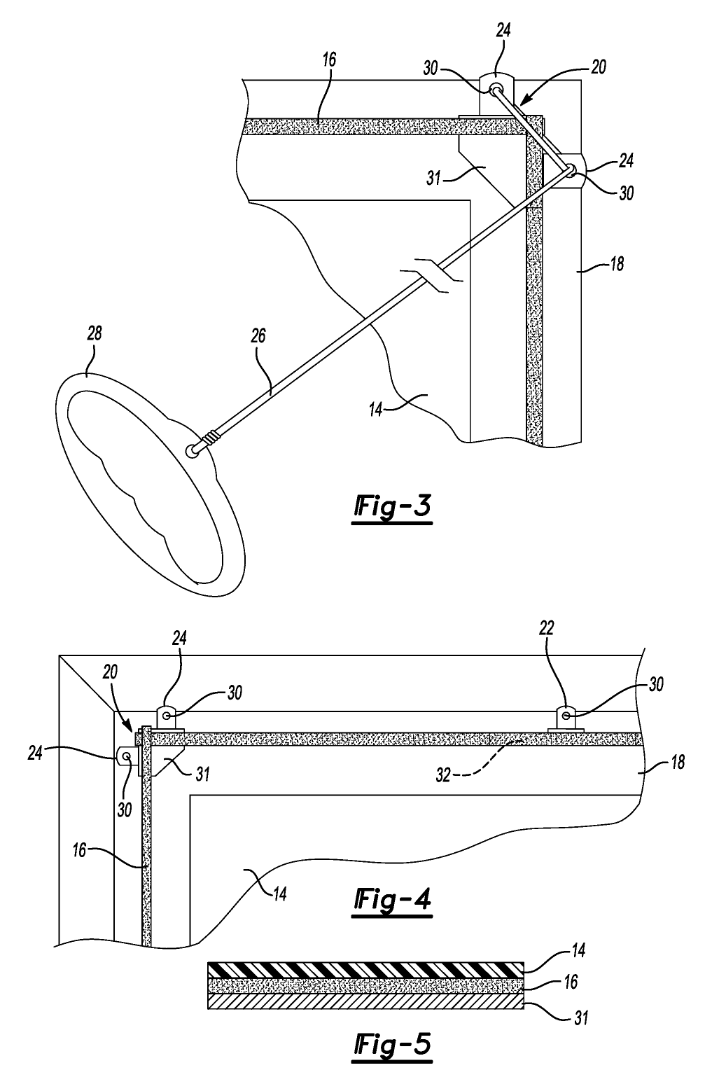

As best seen in FIG. 3 an emergency pull 24 includes a cord 26 attached to the pull tab 20 and/or the pull tab 22 and a pull handle 28 is attached to the end of the cord 26. Upon pulling of the pull handle 28, the insulator film 14 is removed from the window frame 18 of the window unit 10 as shown in FIG. 2. After the insulator film 14 has been removed from the window unit 10, in an emergency such as a fire, an individual can open the window 12 and escape through the window unit 10.

As best seen in FIG. 4 it is preferred that the corner pull tab 20 be provided at one of the upper corners of the window 10. The tab 20 includes a pair of pulls 24 joined by the body 31. Each of the pulls 24 is preferably provided with an aperture 30 to permit easy grasping of the tab 20 and or providing for receipt of the cord 26 which preferably extends through the adjacent pulls 24 so that pulling on the cord 24 causes the pulls 24 to substantially simultaneously urge the insulator film 14 to move away form the window 10.

Still referring to FIG. 4 the center pull tab 22 includes the elongated body 32 to provide the means for attaching the tab 22 to the underside of the insulator film 14. The pull tab 22 is provided with an aperture 34 either to receive a cord (not shown) or in the absence of a cord to provide the means for grasping the tab 22. The pull tab 22 is preferably attached by tape 16 to the underside of the film 14 to more easily permit removal of the film by grasping and pulling on the tab 22.

In the event that a rapid escape may be desired from a particular window unit, for example if a fire were to occur within a residential structure and exit from a bedroom window were needed, the pull 24 attached to one or more of the corner pull tabs 20 or to the center pull tab 22 can be used for rapid removal of the insulator film 14 from the window unit 10.

It is appreciated that the pull tabs 20, 22 can be made from any material known to those skilled in the art, illustratively including metals, alloys, plastics, ceramics, wood and the like. It is also appreciated that the cord 26 is made from any cord type material known to those skilled in the art, illustratively including rope, hemp, plastic materials, cloth fibers, and the like. And finally, it is appreciated that the pull handles 28 can be made from any material known to those skilled in the art, illustratively including plastics, metals, alloys, ceramics, wood and the like.

While the present invention is particularly useful in the event of a fire or other emergency in the home or commercial establishment should such an event not occur when it is desirable to remove the insulator film 14 the present invention provides an easy and convenient way to do so as opposed to the present way such removal is accomplished. With prior art methods the film 14 is difficult to grasp and very often pieces of the tape 16 remain on the window frame or molding 18 as the film 14 is pulled away form the window 12. The provision of the pull tabs 20, 22 having a portion beneath the underside of the double sided tape 16 makes it more likely that the tape 16 will be removed with the film 14 when the tabs 20 22 are pulled to remove the film from the window 12.

The invention is not restricted to the illustrative examples described above. The examples are not intended as limitations on the scope of the invention. Methods, apparatus, compositions and the like described herein are exemplary and not intended as limitations on the scope of the invention. Changes therein and other uses will occur to those skilled in the art.

I claim:

1. A window insulator film removal device for removing a window insulator film from a window frame comprising:
a pull tab having a body operable to be attached to the insulator film, said tab also having a finger pull tab operable to be grasped by an individual and pulled upon.

2. The device as defined in claim 1 and including a chord attached to said tab.

3. The device as defined in claim 2 and including a handle attached to the end of said chord.

4. The device as defined in claim 1 and in which said film is attached to said window frame by double sided tape and said pull tab body being disposed between said body of said pull tab and said window frame.

5. A window insulator film removal device for rapidly removing a window insulator film from a window frame comprising:
a corner pull having a body and a pull tab attached to said body;
said corner pull being attached to the window insulator film using double sided adhesive mounting tape, said body of said corner pull being disposed between said tape and the window frame;
a cord having a first end and a second end, said first end attached to said pull tab and;
a handle attached to said second end of said cord to be grasped and pulled upon, for the purpose of pulling said corner pull with the window insulator film attached thereto away from the window frame.

6. A window insulator film removal device for rapidly removing a window insulator film from a window frame comprising:
a central pull having a body and a pull tab attached to said body;
said corner pull being attached to the window insulator film using double sided adhesive mounting tape, said body of said corner pull being disposed between said tape and the window frame;
a cord having a first end and a second end, said first end attached to said pull tab and;
a handle attached to said second end of said cord to be grasped and pulled upon, for the purpose of pulling said corner pull with the window insulator film attached thereto away from the window frame.
